(19) United States
(12) Patent Application Publication
(10) Pub. No.: US 2008/0055710 A1
(43) Pub. Date: Mar. 6, 2008

(54) DIFFRACTIVE OPTICAL MODULATOR

(75) Inventor: Sang Kyeong Yun, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/849,131

(22) Filed: Aug. 31, 2007

(30) Foreign Application Priority Data
Aug. 31, 2006 (KR) 1020060083578

(51) Int. Cl. G02B 26/02

(52) U.S. Cl. 359/291; 359/290

(57) ABSTRACT

Disclosed herein is a diffractive optical modulator. The diffractive optical modulator includes a base member, a first reflective element, a second reflective element, and an actuating means.

### CROSS REFERENCE TO RELATED APPLICATION

This application claims the benefit of Korean Patent Application No. 10-2006-0083578, filed on Aug. 31, 2006, entitled “Diffractive Optical Modulator,” which is hereby incorporated by reference in its entirety into this application.

### BACKGROUND OF THE INVENTION

1. Field of the Invention

The present invention relates generally to a diffractive optical modulator and, more particularly, to a diffractive optical modulator in which a lower reflective element is formed on a base member and a plurality of upper reflective surfaces is arrayed on a transmissive support plate above the base member, so that diffracted light corresponding to one pixel of a scan line, which is projected onto a screen, can be formed by actuating the transmissive support plate having a ribbon shape.

2. Description of the Related Art

In general, optical signal processing is advantageous in terms of high-speed and parallel processing capability and large-capacity information processing, unlike existing digital information processing, in which it is impossible to process a large amount of data in real time. Research has been conducted on the design and fabrication of binary phase filters, optical logic gates, optical amplifiers, image processing techniques, optical elements, and optical modulators using spatial optical modulation theory.

Of them, the spatial optical modulators have been used in the fields of optical memory, optical displays, printers, optical interconnection, holograms and so on. Development and research have been conducted on display devices using the same.

An example of such a spatial optical modulator is the reflective deformable grating optical modulator 10 shown in FIG. 1. The modulator 10 is disclosed in U.S. Pat. No. 5,311,360, which was granted to Bloom et al. The modulator 10 includes a plurality of deformable reflective ribbons 18 that have respective reflective surfaces, are suspended over a substrate 16, and are spaced apart from each other at regular intervals. An insulating layer 11 is deposited on a silicon substrate 16. A sacrificial silicon dioxide layer 12 and a low-stress silicon nitride layer 14 are then deposited.

The silicon nitride layer 14 is patterned from the ribbons 18, and part of the silicon dioxide layer 12 is etched away, so that the ribbons 18 are held on the oxide spacer 12 with the help of a nitride frame 20.

In order to modulate light having a single wavelength λ, the modulator is designed such that the thickness of the ribbons 18 and the thickness of the oxide spacer 12 is λ/4.

The grating amplitude of the modulator 10, which is restricted to the vertical distance d between the reflective surface 22 of the ribbons 18 and the reflective surface of the substrate 16, is controlled by applying voltage between the ribbons 16 (the reflective surface 22 of the ribbons 16, which serves as a first electrode) and the substrate 16 (a conductive layer 24 below the substrate 16, which serves as a second electrode).

In the state in which the modulator is not deformed, that is, in the state in which no voltage is applied thereto, the grating amplitude is λ/2, and the total path difference between beams of light reflected from the ribbons and the substrate is λ, so that the phase of reflected light is reinforced.

Accordingly, in the state in which the modulator is not deformed, the modulator 10 reflects light as a planar mirror. The state in which the modulator is not deformed is indicated by the reference numeral 20 of FIG. 2, which shows incident light and reflected light.

When an appropriate voltage is applied between the ribbon 18 and the substrate 16, electrostatic force deforms the ribbon 18 downward toward the upper surface of the substrate 16. In the downwardly deformed state, the grating amplitude is λ/4. The total path difference is ½ of a wavelength, and light reflected from the deformed ribbon 18 and light reflected from the substrate 16 are offset and interfere with each other.

As a result of this interference, the modulator diffracts incident light 26. The deformed states are indicated by the reference numerals 28 and 30 of FIG. 3, which shows beams of light diffracted in +/−diffraction modes D+1 and D−1.

Meanwhile, the type of optical modulator described in the patent issued to Bloom et al. can be used as a device for displaying images. In this case, one pixel may be formed using at least two neighboring ribbons. Of course, one pixel may be formed using three, four or six ribbons.

However, the type of optical modulator described in the patent issued to Bloom et al. has some limitation related to the realization of small size. In other words, the width of the ribbons of the optical modulator cannot be set equal to or less than 3 μm, and the distance between the ribbons cannot be set equal to or less than 0.5 μm.

Further, since the construction of a pixel using ribbons requires at least two ribbons, there is a limitation on the realization of a small-sized device.

### SUMMARY OF THE INVENTION

Accordingly, the present invention has been made keeping in mind the above problems occurring in the prior art, and the present invention is intended to provide a diffractive optical modulator that can acquire diffracted light capable of forming one pixel using at least one ribbon, thereby enabling the realization of a small-sized product.

The present invention provides a diffractive optical modulator, including a base member; a first reflective element configured to have a center portion that is spaced apart from the base member to provide space, made of transmissive material to pass incident light therethrough, configured to have a reflective surface that is disposed on part of the center portion, is opposed to the base member and reflects incident light, and supported by the base member; a second reflective element disposed between the first reflective element and the base member, and configured to have a reflective surface that is spaced apart from the first reflective element and reflects light passing through the first reflective element; and an actuating means for moving the center portion of the first reflective element with respect to the second reflective element, and changing intensity of diffracted light formed by beams of reflected light from the first reflective element and the second reflective element.

Additionally, the present invention provides a diffractive optical modulator, including a base member; a plurality of first reflective elements arranged to form an array, supported by the base member, configured to have a center portion spaced apart from the base member to provide space and to have part of a surface opposed to the base member formed as a reflective surface for reflecting incident light, and made of transmissive material to pass incident light therethrough; a second reflective element disposed between the base member and the first reflective elements to be spaced apart from the first reflective elements and provide space, and configured to have a reflective surface for reflecting light passing through the first reflective elements; and a plurality of actuating means for moving center portions of the first reflective elements close to or away from the base member, and changing intensity of diffracted light formed by beams of reflected light from the first reflective elements and the second reflective element.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a conventional electrostatic grating optical modulator;

FIG. 2 is a view showing the state in which the conventional electrostatic grating optical modulator reflects incident light in the state in which it is not deformed;

FIG. 3 is a view showing the state in which the conventional grating optical modulator diffracts incident light in the state in which it is deformed by electrostatic force;

FIG. 4A is a perspective view of a diffractive optical modulator according to an embodiment of the present invention, FIG. 4B is a plan view of the diffractive optical modulator according to the embodiment of the present invention, FIG. 4C is a sectional view of the diffractive optical modulator taken along line A-A′ of FIG. 4B, FIG. 4D is a sectional view of the diffractive optical modulator taken along line B-B′ of FIG. 4B, and FIG. 4E is a sectional view of the diffractive optical modulator according to an embodiment of the present invention, which shows the actuation of a transmissive support plate when the diffractive optical modulator is driven;

FIG. 5A is a view showing the state in which the diffractive optical modulator according to the embodiment of the present invention reflects incident light in the state in which it is not deformed, and FIG. 5B is a view showing the state in which the diffractive optical modulator according to the embodiment of the present invention diffracts incident light in the state in which it is deformed; and

FIG. 6A is a perspective view of a diffractive optical modulator according to another embodiment of the present invention, FIG. 6B is a plan view of the diffractive optical modulator according to the embodiment of the present invention, FIG. 6C is a plan view of a diffractive optical modulator according to still another embodiment of the present invention, and FIG. 6D is a sectional view of the diffractive optical modulator taken along line A-A′ of FIG. 6B.

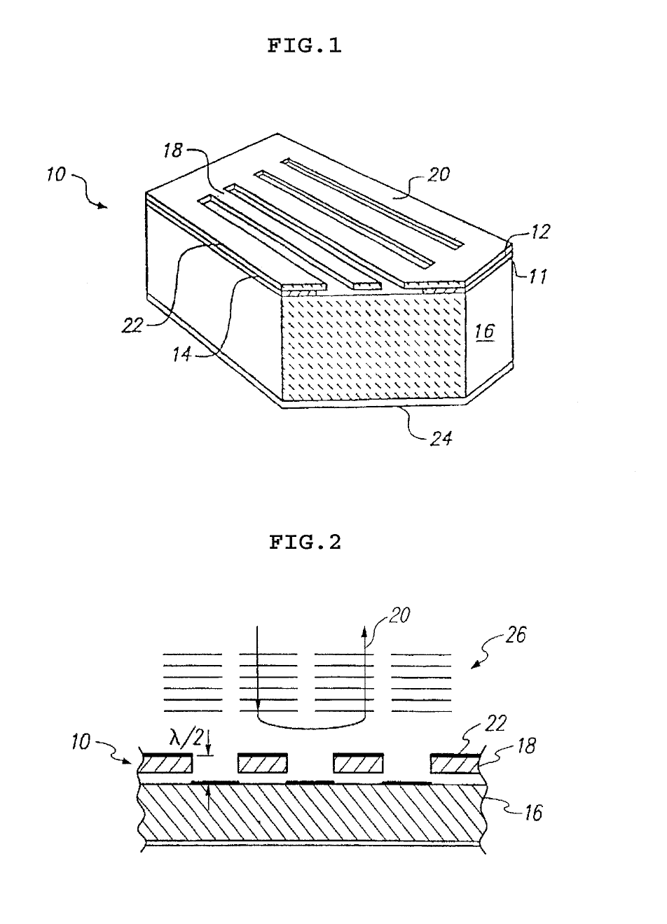

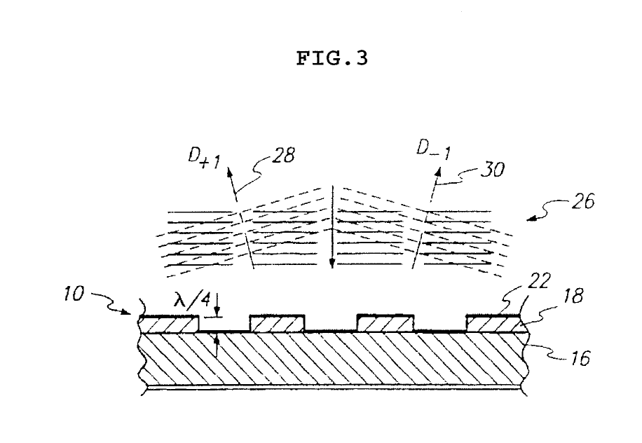

### DESCRIPTION OF THE PREFERRED EMBODIMENTS

The present invention is described in detail in connection with preferred embodiments with reference to the accompanying drawings below.

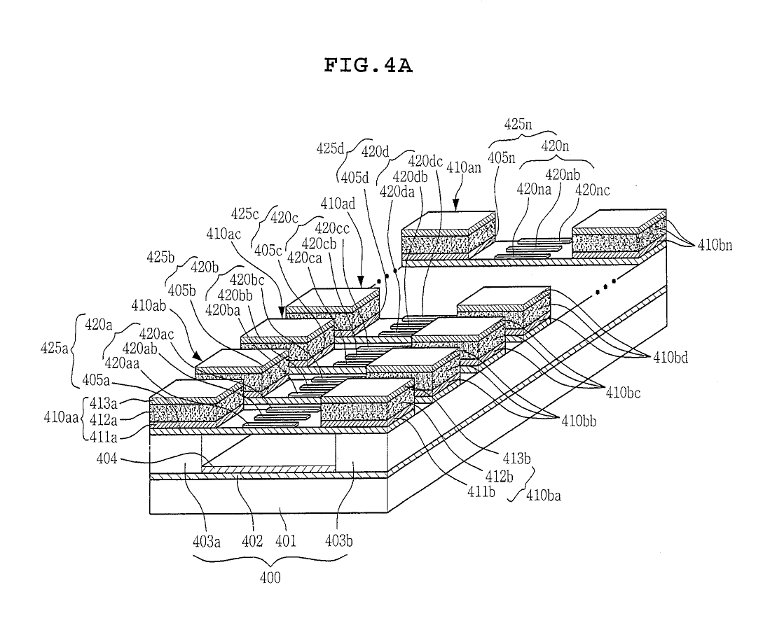

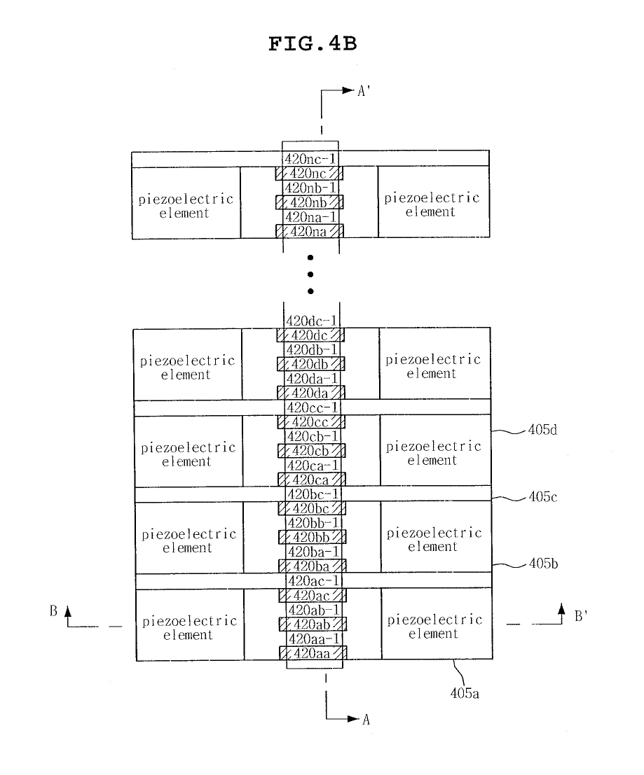

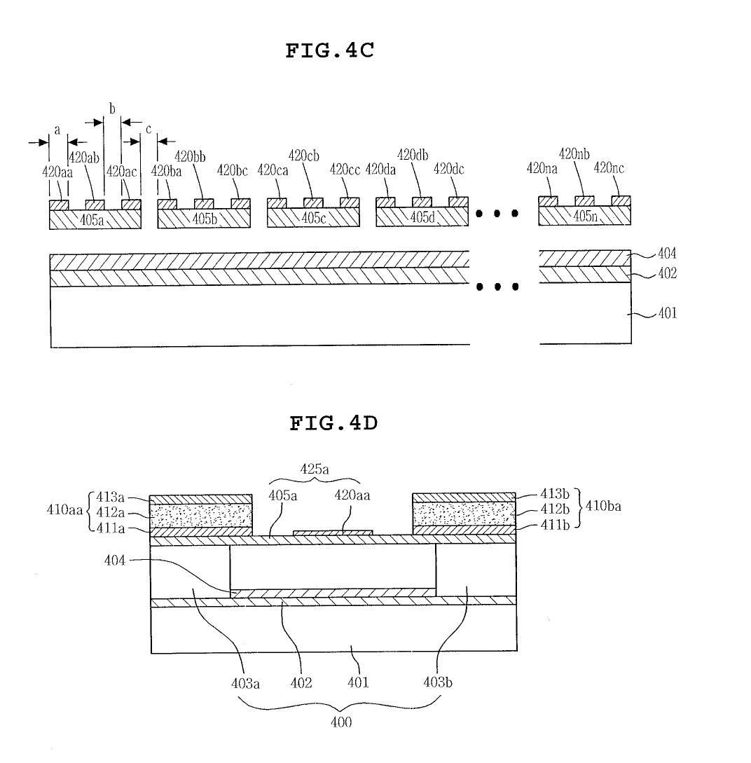

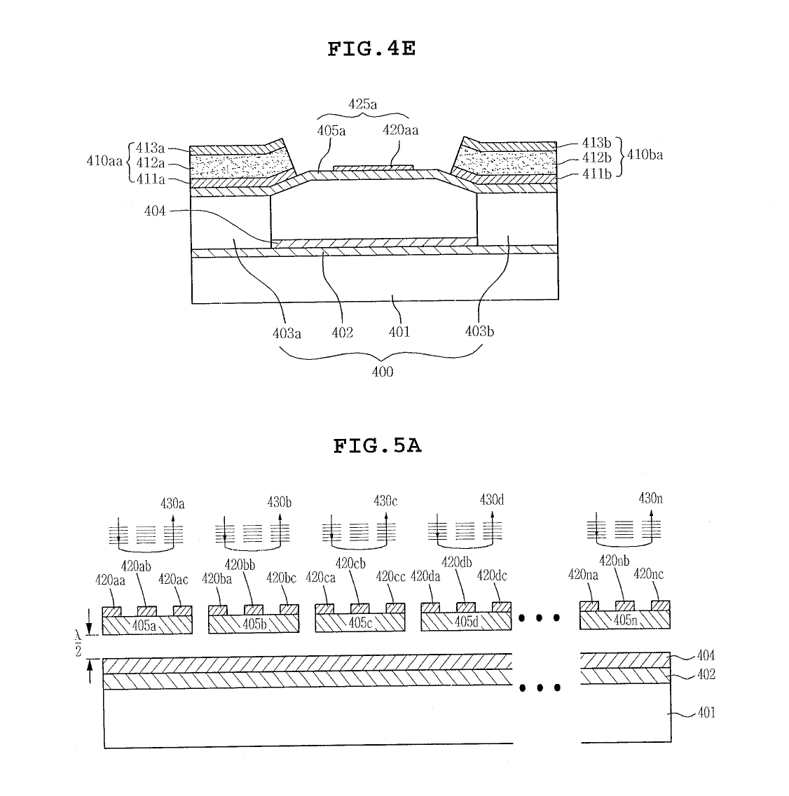

FIG. 4A is a perspective view of a diffractive optical modulator according to an embodiment of the present invention, FIG. 4B is a plan view of the diffractive optical modulator according to the embodiment of the present invention, FIG. 4C is a sectional view of the diffractive optical modulator taken along line A-A′ of FIG. 4B, FIG. 4D is a sectional view of the diffractive optical modulator taken along line B-B′ of FIG. 4B, and FIG. 4E is a sectional view of the diffractive optical modulator according to an embodiment of the present invention, which shows the actuation of a transmissive support plate when the diffractive optical modulator is driven.

Referring to FIGS. 4A to 4E, the diffractive optical modulator according to the embodiment of the present invention includes a flat substrate 401. A silicon substrate may be used as the substrate 401. The substrate 401 may be made of a single compound, such as Si, Al₂O₃, ZrO₂, quartz or SiO₂. A glass substrate may be used as the substrate 401.

The diffractive optical modulator includes an insulating layer 402 formed on the substrate 401. The insulating layer 402 may be omitted depending on the application. Although the insulating layer 402 is illustrated as being formed on the entire surface of the substrate 401 in FIGS. 4C, 4D, and 4E, it may alternatively be formed only under a lower reflective element 404.

The diffractive optical modulator includes a pair of support members 403a and 403b, which are formed above the substrate 401, have the shapes of rectangular columns the length of which is much longer than the height thereof, have sides facing each other, are parallel to each other (they are not exactly parallel to each other), are spaced apart from each other by a specific distance, and have a specific height. Of course, the support members 403a and 403b do not necessarily need to have a rectangular column shape. The support members 403a and 403b need only be constructed such that they protrude from the substrate 401 and allow transmissive support plates 405a˜405n (which will be described below) to be disposed thereon and suspended above the substrate 401.

Silicon substrates may be used as the support members 403a and 403b. The support members 403a and 403b may be made of a single compound, such as Si, Al₂O₃, ZrO₂, quartz or SiO₂. Alternatively, glass substrates may also be used as the support members 403a and 403b. In this case, the substrate 401, the insulating layer 402, and the support members 403a and 403b may be collectively referred to as a base member 400.

The diffractive optical modulator includes the lower reflective element 404, which is formed on the insulating layer 402 of the substrate 401 and reflects incident light. The lower reflective element 404 is located between the pair of support members 403a and 403b. That is, the lower reflective element 404 is formed below the transmissive support plates 405a˜405n, and reflects incident light passing through the transmissive support plates 405a˜405n and also incident light passing between the transmissive support plates 405a˜405n. A micromirror may be used as the lower reflective element 404. The lower reflective element 404 may be made of metal material, such as Al, Pt, Cr or Ag. Although the lower reflective element 404 may be formed on the entire surface of the insulating layer 402 of the substrate 401, it may be formed only below portions where there are no upper reflective elements 420aa˜420nc (which will be described later), as shown in FIG. 4C.

The diffractive optical modulator includes the plurality of transmissive support plates 405a˜405n, which have ribbon shapes, are each attached to the pair of support members 403a and 403b on the opposite sides thereof, are suspended above the substrate 401, can be moved vertically, form an array, and are made of light transmissive material through which incident light can pass. The transmissive support plates 405a˜405n are made of light transmissive material, such as glass, quartz or polymer.

The diffractive optical modulator includes a plurality of pairs of piezoelectric elements 410aa, 410ba˜410an, and 410bn, which are paired, are each formed on respective opposite sides of each of the transmissive support plates 405a˜405n, are mostly formed on the transmissive support plates 405a˜405n on the support members 403a and 403b, and are partially formed on the transmissive support plates 405a˜405n above the substrate 401.

Each of the plurality of pairs of piezoelectric elements 410aa, 410ba˜410an, and 410bn includes lower electrode layers 411a and 411b made of conductive material (only reference numerals assigned only to one pair of piezoelectric elements 410aa, 410ba are indicated here), piezoelectric material layers 412a and 412b respectively formed on the lower electrode layers 411a and 411b and configured to contract and expand when voltage is applied, and upper electrode layers 414a and 413b made of conductive material and respectively formed on the piezoelectric material layers 412a and 412b. The upper electrode layers 414a and 413b and the lower electrode layers 411a and 411b may be made of material, such as Pt, Ta/Pt, Ni, Au, Al, Ti/Pt, IrO₂, or RuO₂, and are deposited within the range from 0.01 to 3 μm using a method such as sputtering or evaporation. The piezoelectric material layers 412a and 412b may be made of vertical piezoelectric material or horizontal piezoelectric material. Alternatively, the piezoelectric material layers 412a and 412b may be made of piezoelectric material, such as PZT, PNN-PT, PLZT, AlN or ZnOt, or a piezoelectric electrolytic material containing at least one element, such as Pb, Zr, Zn or Ti.

The operation of the piezoelectric elements 410aa, 410ba˜410an, and 410bn is described using a pair of piezoelectric elements 410aa and 410ba as examples below.

When voltage is applied to the pair of upper electrode layers 414a and 413b of the pair of piezoelectric elements 410aa and 410ba, the pair of piezoelectric elements 412a and 412b contract or expand, so that the transmissive support plate 105a is moved vertically by actuating force generated through the contraction or expansion of the piezoelectric material layers 412a and 412b. In other words, when voltage is applied to the upper electrode layers 414a and 413b in the state before actuation shown in FIG. 4D, the piezoelectric material layers 412a and 412b contract or expand. In this case, the first sides of the piezoelectric material layers 412a and 412b cannot move because they are firmly attached to the support members 403a and 403b, and the second sides of the piezoelectric material layers 412a, 412b can vertically move the transmissive support plate 405a because they are attached to the movable transmissive support plate 405a, thus deforming the transmissive support plate 405a, as shown in FIG. 4E.

Meanwhile, the diffractive optical modulator includes a plurality of upper reflective surface arrays 420a to 420n, which are respectively formed on the transmissive support plates 405a˜405n, and each include a plurality of upper reflective surfaces 420aa, 420ab and 420ac. The upper reflective surface arrays 420a to 420n form an array, are spaced apart from each other at regular intervals, and are made of reflective material that reflects incident light. Although the upper reflective surface arrays 420a to 420n are formed on the transmissive support plates 405a˜405n, they may be formed beneath the transmissive support plates 405a˜405n.

From FIG. 4B, it can be seen that the upper reflective surface arrays 420a to 420n are formed parallel to the longitudinal direction of the transmissive support plates 405a˜405n.

The upper reflective surfaces 420aa, 420ab and 420ac are located on the center portions of the transmissive support plates 405a˜405n, as shown in FIG. 4D, but they may be extended further.

In an embodiment, the upper reflective surfaces 420aa, 420ab and 420ac may have the same width. In an embodiment, the upper reflective surfaces 420aa, 420ab and 420ac may have the same interval, the interval of the upper reflective surfaces 420aa, 420ab and 420ac being the same as the width of the upper reflective surfaces 420aa, 420ab and 420ac (in FIG. 4C, a=b). Furthermore, the upper reflective surfaces 420aa, 420ab and 420ac may have a width that is the same as the interval of the transmissive support plates 405a˜405n. The upper reflective surfaces 420aa, 420ab and 420ac may have the same width and interval as the transmissive support plates 405a˜405n (in FIG. 4C, a=b=c).

Meanwhile, light incident on the upper reflective surfaces 420aa˜420nc is incident on the center portions thereof in a linear light form, as can be seen from FIG. 4B.

The upper reflective surfaces 420aa˜420nc reflect incident light, as shown in FIG. 4B. The transmissive surfaces 420aa-1˜420nc-1 of the transmissive support plates disposed between the upper reflective surfaces 420aa˜420nc pass incident light therethrough. The passed light is reflected from the lower reflective element 404, and is then emitted.

The light, which passes through the transmissive surfaces 420aa-1˜420nc-1 of the transmissive support plates between the upper reflective surfaces 420aa˜420nc and neighboring upper reflective surfaces 420aa˜420nc and is then reflected from the lower reflective element 404, as described above, forms diffracted light.

The extent of diffraction of the incident light is adjusted by adjusting the interval between the upper reflective surfaces 420aa˜420nc and the lower reflective element 404. In this case, assuming that the wavelength of the incident light is λ, the diffraction efficiency of +/−first-order diffracted light is maximal when the interval between the upper reflective surfaces 420aa˜420nc and the lower reflective element 404 is a multiple of λ/4.

A description is made below, taking the upper reflective surfaces 420aa, 420ab, and 420ac as an example. When light is incident on the upper reflective surfaces 420aa, 420ab, and 420ac, the incident light is reflected therefrom, thus forming reflected light. At this time, light incident on the transmissive surfaces 420aa-1, 420ab-1, and 420aa-1 of the transmissive support plate between the upper reflective surfaces passes through the transmissive support plates 420aa-1, 420ab-1, and 420aa-1, and is then reflected from the lower reflective element 404, thus forming reflected light. The reflected light meets light reflected from the upper reflective surfaces 420aa, 420ab and 420ac, thus forming diffracted light. At this time, assuming that the wavelength of the incident light is λ, the highest +/−first-order diffraction efficiency can be obtained when the interval between the upper reflective surfaces 420aa, 420ab and 420ac and the lower reflective element 404 is a multiple of λ/4. In this case, the transmissive support plates 405a˜405n and the upper reflective surface arrays 420a˜420n can be collectively referred to as upper reflective elements 425a˜425n.

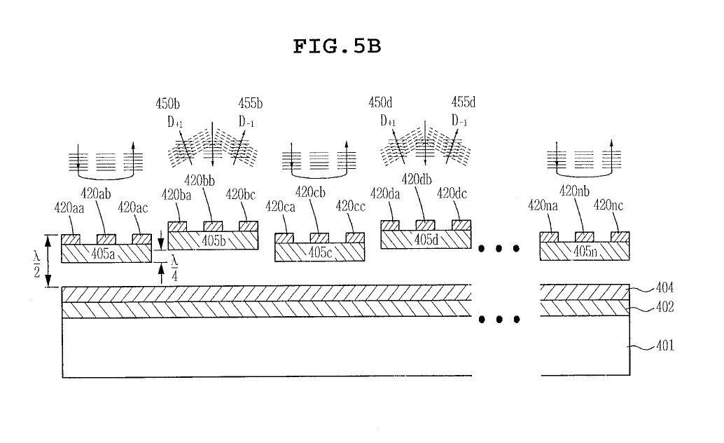

FIG. 5A is a view showing the state in which the diffractive optical modulator according to the embodiment of the present invention reflects incident light, and FIG. 5B is a view showing the state in which the diffractive optical modulator according to the embodiment of the present invention diffracts incident light.

Referring to FIG. 5A, in the diffractive optical modulator according to the embodiment of the present invention, the transmissive support plates 405a˜405n are adjusted, so that the transmissive support plates 405a˜405n and the lower reflective element 404 form λ/2 when the wavelength of incident light is λ.

In this case, the grating amplitude of the transmissive support plates 405a˜405n and the lower reflective element 404 is λ/2, and the overall difference between the paths of beams of light reflected from the upper reflective surfaces 420aa˜420nc and the lower reflective element 404 is λ, so that the light reflected from the upper reflective surfaces 420aa˜420nc and the light reflected from the lower reflective element 404 have enhanced phases.

Accordingly, in this state, the diffractive optical modulator reflects light as a planar mirror.

When an appropriate voltage is applied to the upper electrode layers 414a and 413b of the piezoelectric elements 410aa, 410ba˜410an, and 401bn in this state, the transmissive support plates 405a˜405n are deformed upward, examples of which are designated by 405b, 405d in FIG. 5B. In the state in which the transmissive support plates 405a˜405n have been deformed upward, the grating amplitude is λ/2+λ/4. The overall path difference is λ+λ/2. Light, which is reflected from the upper reflective surfaces 405ba, 405bb, 405bc, 405da, 405db and 405dc of the deformed transmissive support plates 405b, 405d, and light, which passes through the transmissive support plates 405b and 405d and is then reflected from the lower reflective element 404, are offset and interfere with each other. As a result, the diffraction efficiency of +/−first-order diffracted light is maximized.

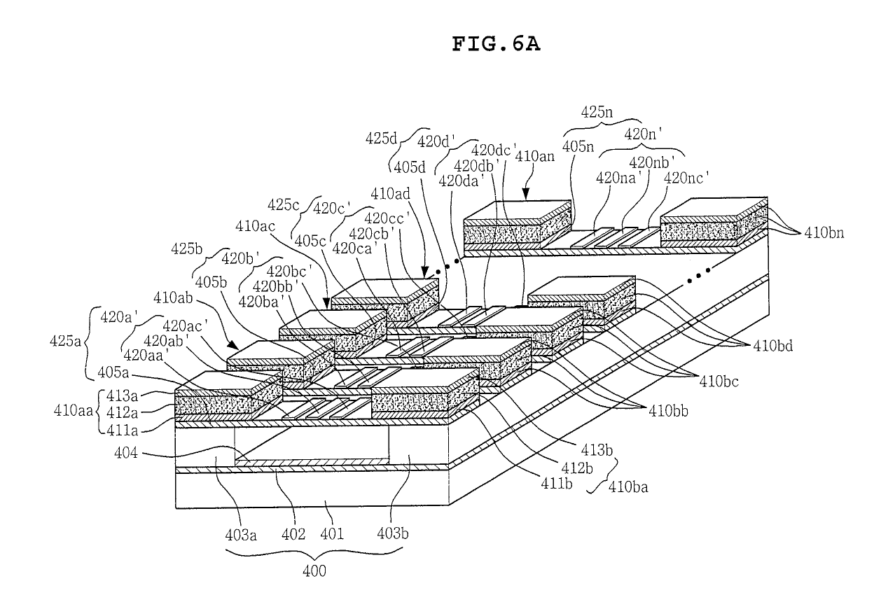

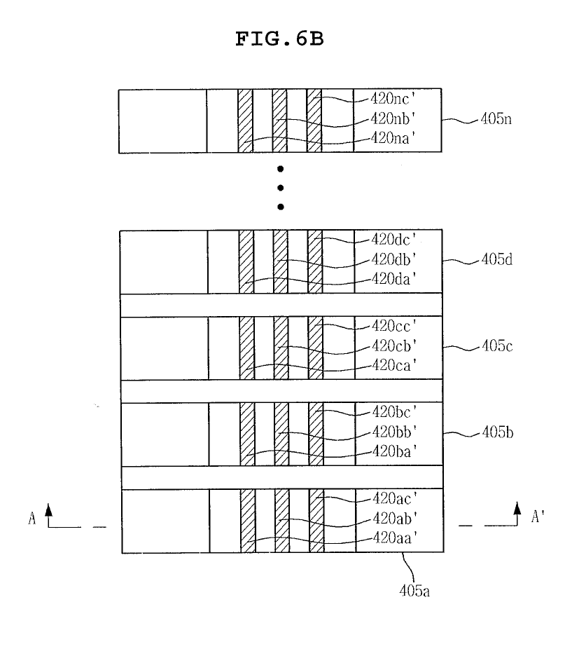

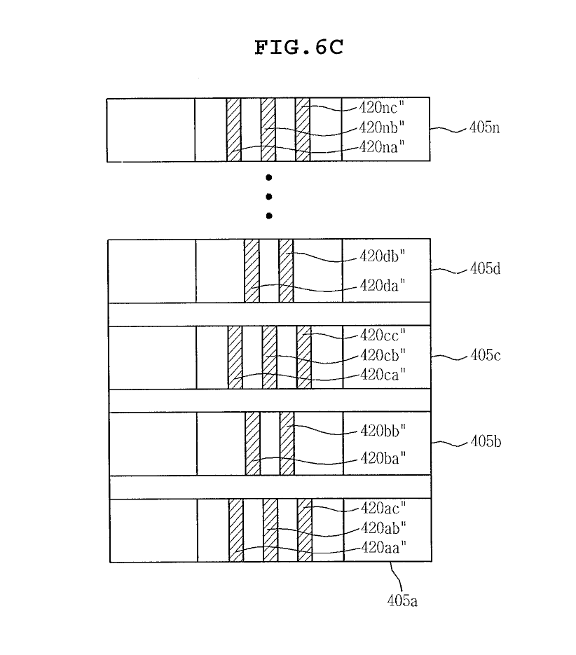

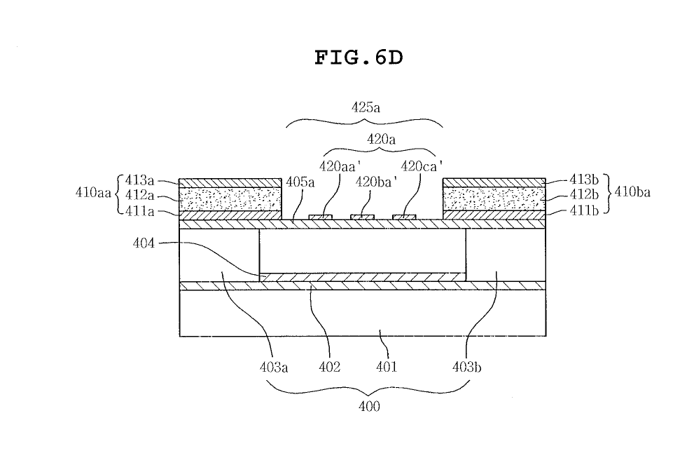

FIG. 6A is a perspective view of a diffractive optical modulator according to another embodiment of the present invention, FIG. 6B is a plan view of the diffractive optical modulator according to another embodiment of the present invention, FIG. 6C is a plan view of a diffractive optical modulator according to still another embodiment of the present invention, and FIG. 6D is a sectional view of the diffractive optical modulator taken along line A-A′ of FIG. 6B.

Referring to FIG. 6A, in the diffractive optical modulator according to the present embodiment of the present invention, the longitudinal sides of upper reflective surfaces 420aa′ to 420nc′ are perpendicular to those of transmissive support plates 405a˜405n, unlike the diffractive optical modulator shown in FIG. 4A according to the previous embodiment of the present invention. This structure can be clearly seen in FIGS. 6Bb and 6D. That is, it can be seen that a plurality of upper reflective surfaces 420aa′-420nc′ is arrayed in a direction vertical to the transmissive support plates 405a˜495n. Referring to FIG. 6B, in this structure, the transmissive support plates 405a˜405n do not need to be spaced apart from each other, and must come into close contact with each other.

Of course, in this structure, the upper reflective surfaces 420aa′˜420nc′ form reflected light by reflecting incident light. Light incident on the transmissive surfaces 420aa-1′ to 420nc-1′ of transmissive support plates between the upper reflective surfaces 420aa′˜420nc′ is passed therethrough and is then reflected from the lower reflective element 404, thus forming reflected light. The beams of reflected light meet each other and form diffracted light.

In this case, assuming that the wavelength of the incident light is λ, when the interval between the upper reflective surfaces 420aa′˜420nc′ and the lower reflective element 404 is adjusted, and thus the height difference is an even multiple of λ/4, the diffraction efficiency of +/−1-order diffracted light is maximized. In contrast, when the height difference is an odd multiple of λ/4, the diffraction efficiency of +/−1-order diffracted light is maximized.

A description is made below, taking the upper reflective surfaces 420aa′, 420ab′, and 420ac′ as examples. When light is incident on the upper reflective surfaces 420aa′, 420ab′, and 420ac′, the incident light is reflected therefrom, thus forming reflected light. At this time, light incident on the transmissive surfaces 420aa-1′, 420ab-1′, and 420aa-1′ of the transmissive support plate between the upper reflective surfaces passes through the transmissive support plates 420aa-1′, 420ab-1′, and 420aa-1′ and is then reflected from the lower reflective element 404, thus forming reflected light. The light reflected from the lower reflective element 404 meets the light reflected from the upper reflective surfaces 420aa′, 420ab′, and 420ac′, thus forming diffracted light. At this time, when the difference between the heights of the upper reflective surfaces 420aa′, 420ab′, and 420ac′ and the lower reflective element 404 is an even multiple of λ/4, the diffraction efficiency of +/−1-order diffracted light is maximized. In contrast, when the difference between the heights of the upper reflective surfaces 420aa′, 420ab′, and 420ac′ and the lower reflective element 404 is an odd multiple of λ/4, the diffraction efficiency of +/−1-order diffracted light is maximized.

Meanwhile, in another embodiment of the present invention shown in FIG. 6A, the upper reflective surfaces 420aa′˜420nc′ on the transmissive support plates 405a˜405n are formed in the same manner.

However, as illustrated in an example of FIG. 6C, in another embodiment of the present invention, the upper reflective surfaces 420aa′˜420nc′ on the transmissive support plates 405a˜405n may be offset from neighboring transmissive support plates 405a˜405n. The operation of the present embodiment is the same as that shown in FIG. 6B.

When the transmissive support plate according to the present invention and the plurality of upper reflective surfaces are employed, a display device having a desired number of pixels can be implemented using a number of transmissive support plates lower than that of the prior art.

For example, in the prior art, one pixel can be implemented using at least two ribbon-shaped upper reflective elements. Furthermore, in the prior art, when the number of ribbon-shaped upper reflective elements forming one pixel is 2, diffraction efficiency is 50% or less. Accordingly, in order to increase diffraction efficiency, four or six ribbon-shaped upper reflective elements are used to form one pixel. When four or more ribbon-shaped upper reflective elements are used to form one pixel as described above, diffraction efficiency is 70% or more, therefore maximum efficiency is realized by increasing the number of upper reflective elements.

In the case where, for example, a 1080×1920 high-resolution digital TV HD format is implemented using the diffractive optical modulator, 1080 pixels are vertically arranged, and each pixel is optically modulated 1920 times, thus forming one frame. In the prior art, when four or six actuation ribbons are used to form one pixel, 1080×4 (or 1080×6) actuation ribbons are required to form 1080 pixels. In the present invention, however, when two or three upper reflective elements 420aa˜420nc are employed, 1080 pixels can be formed using only 1080×1 ribbon-shaped upper reflective elements. Accordingly, the fabrication of a device is easy, the production efficiency thereof is increased, and a small-sized device can be manufactured.

Meanwhile, although the base member 400 has been described in conjunction with a base member in which the support members 403a and 403b are formed on the substrate 401, the space over which the first reflective elements 425a˜425n can be suspended may be formed by forming a recess in the substrate 401.

Although the piezoelectric layers 410aa˜420an and 420ba˜420bn are implemented to include the single piezoelectric material layers 410ab and 410bb, the piezoelectric layers 410aa˜420an and 420ba˜420bn may be implemented using a plurality of piezoelectric material layers and a plurality of electrode layers.

Furthermore, the above-mentioned upper reflective elements 425a˜425n may also be used as the lower electrode layers 410aa, 410ba of the piezoelectric layers 410aa˜420an and 420ba˜420bn.

As described above, the present invention is advantageous in that diffracted light capable of realizing a single pixel image on a screen can be obtained using only one upper reflective element.

In accordance with the present invention, diffracted light having improved diffraction efficiency can be acquired by forming a plurality of upper reflective surfaces on a transmissive support plate.

Furthermore, according to the present invention, a single upper reflective element can replace the four or six upper reflective elements of the prior art, and thus the yield can be improved in the fabrication process and the manufacturing cost can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A diffractive optical modulator, comprising:
a base member;
a first reflective element configured to have a center portion that is spaced apart from the base member to provide space, made of transmissive material to pass incident light therethrough, configured to have a reflective surface that is disposed on part of the center portion, is opposed to the base member and reflects incident light, and supported by the base member;
a second reflective element disposed between the first reflective element and the base member, and configured to have a reflective surface that is spaced apart from the first reflective element and reflects light passing through the first reflective element; and
actuating means for moving the center portion of the first reflective element with respect to the second reflective element, and changing intensity of diffracted light formed by beams of reflected light from the first reflective element and the second reflective element.

2. The diffractive optical modulator as set forth in claim 1, wherein the base member comprises:
a substrate; and
a support member configured to protrude from the substrate and support the first reflective element so that the center portion of the first reflective element forms space along with the substrate;
wherein the second reflective element is disposed on the substrate and reflects incident light passing through the first reflective element.

3. The diffractive optical modulator as set forth in claim 2, wherein the base member further comprises an insulating layer that is formed between the substrate and the second reflective element.

4. The diffractive optical modulator as set forth in claim 1, wherein:
the base member is provided with a recess for providing the space;
the second reflective element is formed in the recess of the base member; and
the first reflective element is disposed across the recess so that the center portion is spaced apart from the first reflective element.

5. The diffractive optical modulator as set forth in claim 1, wherein the first reflective element comprises:
a first support plate configured to have a center portion spaced apart from the base member to form space, supported by the base member, and configured to pass incident light therethrough; and
a first reflective surface formed on part of the center portion of the first support plate, and configured to reflect incident light on a surface opposed to the base member.

6. The diffractive optical modulator as set forth in claim 1, wherein the first reflective element comprises:
a first support plate configured to have a center portion spaced apart from the base member to form space, supported by the base member, and configured to pass incident light therethrough; and
a first reflective surface array configured to include a plurality of first reflective surfaces, the plurality of first reflective surfaces being formed on part of the center portion of the first support plate and reflecting incident light on a surface opposed to the base member.

7. The diffractive optical modulator as set forth in claim 5, wherein a longitudinal side of the first reflective surface of the first reflective element is arranged in a transverse direction of the base member.

8. The diffractive optical modulator as set forth in claim 7, wherein a width of the first reflective element is almost identical to that of the transmissive surface of the transmissive support plate.

9. The diffractive optical modulator as set forth in claim 7, wherein a width of the first reflective element is almost identical to an interval between the transmissive support plates.

10. The diffractive optical modulator as set forth in claim 7, wherein a width of the first reflective element, a width of the transmissive surfaces of the transmissive support plates, and an interval between the transmissive support plates are almost identical to each other.

11. The diffractive optical modulator as set forth in claim 5, wherein a longitudinal side of the first reflective surface of the first reflective element is arranged in a direction perpendicular to a direction in which the first reflective element crosses the base member.

12. The diffractive optical modulator as set forth in claim 1, wherein the actuating means comprises piezoelectric means that has a first end disposed on a first side of the first reflective element and a second end disposed on a first side spaced from the center portion of the second reflective element, comprises a piezoelectric material layer and an electrode layer used to apply voltage to both sides of the piezoelectric material layer, and provides actuating force through contraction and expansion of the piezoelectric material layer when voltage is applied to the electrode layer.

13. The diffractive optical modulator as set forth in claim 12, wherein the piezoelectric means comprises at least two piezoelectric layers that are formed on the first reflective element and are spaced apart from each other.

14. The diffractive optical modulator as set forth in claim 12, wherein the first reflective element functions as the electrode layer.

15. The diffractive optical modulator as set forth in claim 12, wherein the piezoelectric means comprises:
a plurality of piezoelectric material layers configured to generate actuating forcer through contraction and expansion when voltage is applied to both sides thereof;
a plurality of first electrode layers disposed between the plurality of piezoelectric material layers, and configured to provide piezoelectric voltage; and
a second electrode layer disposed on an outmost layer of the piezoelectric material layers, and configured to provide piezoelectric voltage.

16. The diffractive optical modulator as set forth in claim 15, wherein the first reflective element functions as the second electrode layer.

17. A diffractive optical modulator, comprising:
a base member;
a plurality of first reflective elements arranged to form an array, supported by the base member, configured to have a center portion spaced apart from the base member to provide space and to have part of a surface opposed to the base member formed as a reflective surface for reflecting incident light, and made of transmissive material to pass incident light therethrough;
a second reflective element disposed between the base member and the first reflective elements to be spaced apart from the first reflective elements and provide space, and configured to have a reflective surface for reflecting light passing through the first reflective elements; and
a plurality of actuating means for moving center portions of the first reflective elements close to or away from the base member, and changing intensity of diffracted light formed by beams of reflected light from the first reflective elements and the second reflective element.

18. The diffractive optical modulator as set forth in claim 17, wherein the base member comprises:
a substrate; and
a support member configured to protrude from the substrate and support a plurality of the first reflective elements so that center portions of the plurality of the first reflective elements are spaced apart from the substrate to provide space.

19. The diffractive optical modulator as set forth in claim 17, wherein:
the base member has a recess for providing the space;
the second reflective element is formed in the recess of the base member; and
the first reflective elements are disposed across the recess so that the center portions of the first reflective elements are spaced apart from the second reflective element with a space formed therebetween, and form an array.
